(19) United States
(12) Patent Application Publication
(10) Pub. No.: US 2018/0014915 A1
(43) Pub. Date: Jan. 18, 2018

(54) Low Profile Orthodontic Bracket

(71) Applicant: Orthoarm, Inc., Toronto (CA)

(72) Inventor: John VOUDOURIS, Toronto (CA)

(21) Appl. No.: 15/548,932

(22) PCT Filed: Feb. 8, 2016
(86) PCT No.: PCT/CA2016/050112

§ 371 Date: Aug. 4, 2017

(30) Foreign Application Priority Data
Feb. 6, 2015 (US) 62112957

(51) Int. Cl. A61C 7/28

(52) U.S. Cl. CPC A61C 7/28

(57) ABSTRACT

The present invention relates to a self-ligating orthodontic bracket with improved characteristics resulting in a lower profile and improved usability. The orthodontic bracket comprises a body including a bonding base for attachment to a tooth, the bonding base having a curvature generally corresponding to the curvature of the tooth. One or more gingival tie wings extend labially from the body and two or more mesiodistally-spaced occlusal tie wings extending labially from the body. An archwire slot extends mesiodistally across the body between the gingival tie wing and the occlusal tie wings. The archwire slot has a lingual base where the lingual base has a hole extending labial-lingually through the bonding base.

### RELATED APPLICATIONS

This application claims priority from U.S. Provisional Patent Application No. 62/112,957 filed Feb. 6, 2015; the contents of which are herein expressly incorporated by reference.

### FIELD OF THE INVENTION

The present invention relates to the field of orthodontic brackets and more particularly to a self-ligating orthodontic bracket with improved characteristics resulting in a lower profile.

### BACKGROUND OF THE INVENTION

Orthodontic treatment is effected by fixing small appliances often referred to as orthodontic brackets to a patient's teeth in an appropriate manner to correct malaligned teeth by applying an external force thereto through an archwire extending between the generally fixed orthodontic brackets. Directions mesial and distal mean generally left to right. Labial is the front surface, while lingual is defined as anything toward the direction of the tongue and thereby the word lingual may also be additionally defined as behind the labial surface. As to the structure of these orthodontic brackets, they are constructed of a body having a main archwire slot and other horizontally, vertically, diagonally oriented slots used to house a clip or locking shutter. The brackets are adhered directly on the labial or lingual sides of the teeth or welded to metal bands attached to the teeth by cementing or by some other method, as is generally known in the art.

As the form of use of the orthodontic bracket constructed as described above, a flexible archwire, which is curved to conform to a dental arch, is placed in an archwire slot in the bracket. The tooth aligns over time by the restoring force of the generally flexible archwire so that the teeth become well aligned. With the orthodontic bracket, a force can be applied to the tooth in a desired direction to change the direction in which the tooth is aligned, rotated, tipped or torqued. This is effected by the three-dimensional inclination of the slot formed in the bracket body or by the desired bending of the archwire. Light, continuous forces are desirable for ideal biological movement that also reduce the risk of root resorption (root shortening).

Orthodontic treatment is accomplished by transmitting the restoring force of the archwires through brackets to the tooth roots. Generally, in an early period of the treatment, a thin, highly flexible round archwire is used, and an operation is required to loosen the ligature wire after ligating it such that the round wire freely slides within the slot (on a very low frictional basis). As treatment progresses, a thicker wire, a square or rectangular wire, and a more highly rigid wire eventually is used. When the alignment is nearly completed, the teeth are retained for a period of several months to prevent relapse. At this time, there are circumstances where the tooth is strongly fastened by a ligature wire so that it practically does not shift.

Various types and designs of self-ligating brackets are known in the art that provide different advantages, or solve particular problems that can also depend on the patient's oral physiology. One type of self-ligating bracket uses a slider mechanism, such as a flat cap or plate that slides in a linear direction within grooves or guides, to retain the archwire in the archwire slot. At one end of the slider mechanism's range, the archwire slot is closed and at the other, it is open. Any of a variety of structures can be used to bias or retain the slider mechanism in its open or its closed position. The invention provides an improvement to this type of passive self-ligating bracket.

One example of this type of bracket is shown in U.S. Pat. No. 6,168,428 to Dr. John Voudouris issued Jan. 2, 2001, and specifically at FIGS. 48 to 52, its entirety herein expressly incorporated by reference. In this bracket, a spring member in the form of a resilient shim 720 located lingually to the labial face of the bracket, projects gingivally, has a jog directed lingually toward the archwire slot 3240d, and presents a generally convex surface 722 towards the archwire slot 3240d. The gingival edge 724 of the shim 720 recurves gingivally after being directed lingually.

As the arms 3540 slide within the slots 3530 to move the clip 3538 to a closed position as shown in FIG. 49, the convex surface 722 of the shim 720 engages the archwire 3242d and provides a continuous biasing action against the archwire. As may be seen in FIG. 51, the resilience of the shim 720 allows the orthodontic bracket 3220d to accommodate different sizes and configurations of archwires 3242d while maintaining a continuous action against the archwire.

U.S. Pat. No. 8,636,507 to Voudouris, herein expressly incorporated by reference in its entirety, discloses a self-ligating orthodontic bracket. The orthodontic bracket has a body with an archwire slot defined at least partially by an occlusal side surface and a lingual surface. A mesio-gingival reference plane is tangent to a lingual-most point of the lingual surface. The body further has an occlusal-gingival opening, wherein the reference plane intersects the opening. A locking shutter is coupled to the body and movable between a closed position where access to the archwire slot is inhibited and an open position where access to the archwire slot is permitted. The locking shutter includes a lingual end located in the opening at a closed lingual location when the locking shutter is in the closed position. The lingual end is located at an open lingual location when the locking shutter is in the open position. The locking shutter further includes a labial end located at a closed labial location when the locking shutter is in the closed position and at an open labial location when the locking shutter is in the open position. The side surface is closer to the open labial location than to the closed labial location. A first occlusal-gingival distance from the closed lingual location to the open lingual location is from 70% to 90% a second occlusal-gingival distance from the closed labial location to the side surface.

U.S. Pat. No. 5,857,849 to Kurz, herein expressly incorporated by reference in its entirety, discloses a self-ligating orthodontic bracket. The bracket has a base plate with a rear surface and a front surface. An adhesive means mounted on said rear surface of said base plate attaches the bracket to the surface of a tooth. The base plate has its front surface provided with a transverse slot for receiving an arch wire in partially engaged position displaced up from the bottom of the slot. A cover plate extends across the front surface of said base plate to cover said base plate and said slot. The cover plate has a lower edge connected to said base plate to cause said cover plate to be resiliently self-biased against the front surface of said base plate for continually and progressively forcing the arch wire down into the transverse slot while the bracket is in place. The cover plate is separated into two sections. A first lateral protuberance is mounted on one of the sections of the cover plate and a second lateral protuberance is mounted on the base plate. The first and second protuberances being used for elastic attachment to enhance cover plate pressure toward the base plate.

There is therefore a need in the art for a self-ligating orthodontic bracket with a lower profile that addresses one or more of the aforementioned problems with the prior art.

### SUMMARY OF THE INVENTION

According to one aspect of the invention, there is provided an orthodontic bracket having a body including a bonding base for attachment to a tooth. The bonding base has a curvature generally corresponding to the curvature of the tooth. The bracket also has one or more gingival tie wings extending labially from the body and two or more mesiodistally-spaced occlusal tie wings extending labially from the body. An archwire slot extends mesiodistally across the body between the gingival tie wing and the occlusal tie wings. The archwire slot has a lingual base with the lingual base having a hole extending labial-lingually through the bonding base. In some embodiments, the hole may be centrally located mesiodistally along the archwire slot and may be shaped like a circle, square, ellipse, rectangle, and it may be irregular-shaped.

According to another aspect of the invention, there is further provided a locking shutter moveable between an open position in which placement and removal of said archwire is facilitated and a closed position in which placement and removal of said archwire is inhibited. The body may have a cavity for receiving a portion of the locking shutter and the cavity may be between the bonding base and the lingual base of the archwire slot such then when the locking shutter is placed in the closed position, the hole may be closed by at least a portion of the locking shutter.

According to yet another aspect of the invention, the locking shutter may have a tool hole for receiving a dental tool. The tool hole may be positioned with respect to the hole in the archwire slot to provide mechanical advantage to the dental tool in removing or installing the shutter. In some aspects, the hole may be aligned mesiodistally with the tool hole.

In some aspects of the invention, the hole location may be determined by the curvature of the bonding base.

According to any aspect of the invention, the locking shutter may be constructed from a resilient nickel-titanium, chromium-cobalt, titanium-molybdenum, spring steel material, or a combination thereof.

According to another aspect of the invention, the hole may be shaped to receive a tool to facilitate placement of the orthodontic bracket on the tooth.

According to yet another aspect of the invention, there is provided an orthodontic bracket having a body including a bonding base for attachment to a tooth. The bonding base has a curvature generally corresponding to the curvature of the tooth. The body may have a cavity therein for receiving at least a portion of a locking shutter. One or more gingival tie wings may extend labially from the body and two or more mesiodistally spaced occlusal tie wings may extend labially from the body. An archwire slot extends mesiodistally across the body between the gingival tie wing and the occlusal tie wings. The archwire slot has a lingual base with a hole centrally-located mesiodistally and extending labial-lingually through to the cavity. The cavity may be located between the bonding base and the lingual base of the archwire slot. The locking shutter may be moveable between an open position in which placement and removal of said archwire is facilitated and a closed position in which placement and removal of said archwire is inhibited. When the locking shutter is placed in the closed position, the hole may be closed by at least a portion of the locking shutter. In some embodiments, the hole may be centrally located mesiodistally along the archwire slot. The hole may be circular shaped, square shaped, ellipse shaped, rectangular shaped, or irregularly shaped. The hole may be symmetrical or asymmetric.

### BRIEF DESCRIPTION OF THE DRAWINGS

The novel features, which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a side view of a prior art orthodontic bracket;

FIG. 2 is a gingival view of the prior art orthodontic bracket;

FIG. 3 is a side view of an orthodontic bracket with low profile;

FIG. 4 is a gingival view of the orthodontic bracket with low profile; and

FIG. 5 is a front view of the orthodontic bracket with low profile.

### DETAILED DESCRIPTION

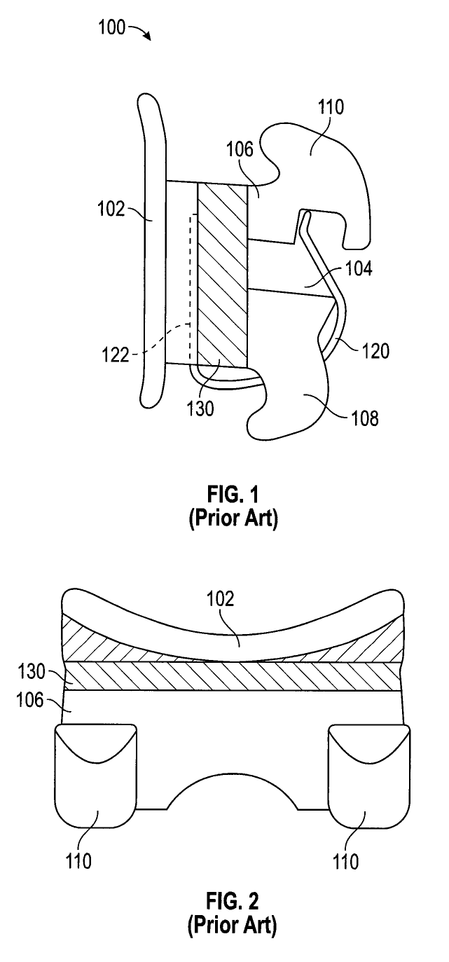

A prior art orthodontic bracket 100 is demonstrated in FIGS. 1 and 2. The prior art bracket 100 comprises a bonding pad 102 (or base) for attachment to a tooth (not shown). An archwire slot 104 extends in a substantially mesiodistal direction across the body 106 of the bracket 100 with an open labial aspect to receive an archwire (not shown). Occlusal tie wings 110 and gingival tie wings 108 are provided on opposed sides of the body 106 and extend labial-lingually from the body 106. These elements are not described in more detail as their purpose and functioning is generally known in the art. A flexible shutter 120 (or clip) is placed within a cavity 122 within the body 106 and the shutter 120 curves around to cover and retain the archwire within the archwire slot 104. In order to preserve the strength of the bracket 100, the body 106 comprises additional material 130 shown in hashed outline in FIGS. 1 and 2. The additional material 130 also allows the bonding pad 102 to encompass the entire back surface of the body 106. This additional surface provides increased surface area to adhere the bonding pad 102 to the body 106 and the tooth.

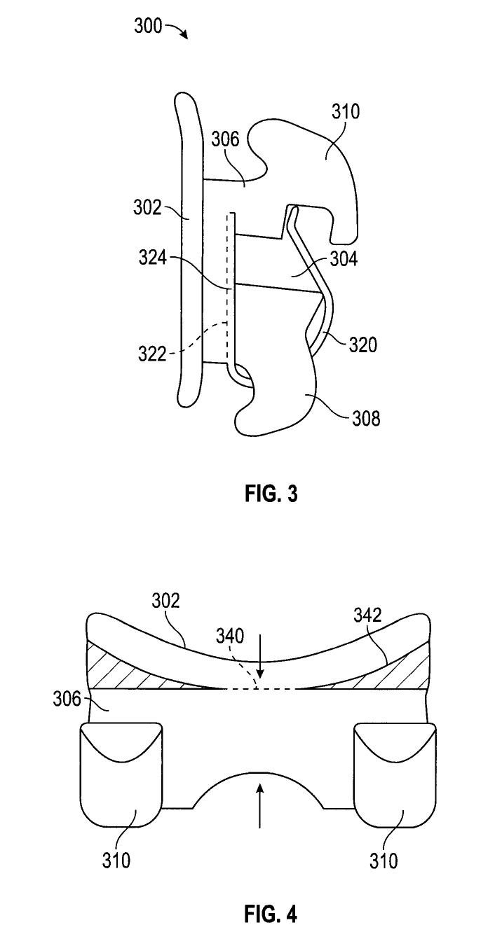

The improved orthodontic bracket 300 is demonstrated in FIGS. 3 to 5. Similar to the prior art bracket 100, the improved bracket 300 comprises a bonding pad 302 for attachment to a tooth. An archwire slot 304 extends in a substantially mesiodistal direction across the body 306 of the bracket 300 with an open labial aspect to receive an archwire (not shown). The archwire slot 304 comprises a lingual base 324. Occlusal tie wings 310 and gingival tie wings 308 are provided on opposed sides of the body 306. These elements are not described in more detail as their purpose and functioning is generally known in the art. A flexible shutter 320 (or clip) is placed within a cavity 322 within the body 306 and the shutter 320 curves around to cover and retain the archwire within the archwire slot 304.

The body 306 has been reduced in depth by approximately 50% of the depth of the prior art bracket body 106. The depth of the body 306 is reduced based on the curvature of the back portion 342 where the curvature generally corresponds to the curvature of the tooth. The depth is reduced such that the lingual base 324 of the archwire slot 304 is perforated at a central portion 340 of the curvature of the back portion 342 while maintaining the strength of the body 306. The mesiodistal sides of the body 306 are thicker than the central perforated portion and provide this strength. The reduction in depth allows for increased patient comfort as the brackets have a resulting lower profile in addition to advantages as further described herein.

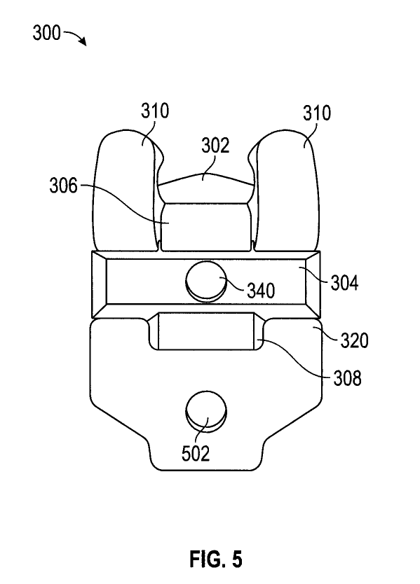

This perforation 340 is seen more clearly in FIG. 5 where it is shown as a circular hole 340 located centrally along the base 324 of the archwire slot 304. This circular hole 340 generally aligns mesiodistally with a hole 502 in the shutter 320. The hole 502 in the shutter 320 is used to facilitate installation and removal of the shutter 320. The installation/removal tool (not shown) may also enter the hole 340 in order to provide additional leverage during installation or removal of the shutter 320. Once the shutter 320 is installed, the portion of the shutter 320 in the cavity 322 forms the back of the archwire slot 304 in the hole 340. This hole 340 may also be used to facilitate placing of the bracket 300 during bonding of the bonding pad to the tooth.

The resilient locking shutter 320 is preferably formed from a resilient nickel-titanium, chromium-cobalt, titanium-molybdenum or spring steel material, or alternatively any resilient material that can apply a force to the archwire within the archwire slot 304 as herein described.

Although the hole 340 is shown as circular, it may be elliptical, rectangular, or square depending on the different torque prescriptions of the teeth. In addition, the hole 340 in the drawings is shown as centrally located within the archwire slot 304 but may be off center in other embodiments. In other embodiments, there may comprise more than one hole 340.

Although a pair of occlusal tie wings and a pair of gingival tie wings are demonstrated, some aspects may be a single occlusal tie wing and/or a single gingival tie wings. Alternatively, there may be more than two occlusal tie wings and/or more than two gingival tie wings. The number of occlusal tie wings and the number of gingival tie wings may be different without departing from the scope of the invention.

The embodiments described herein comprise a cavity 322, which receives the shutter 320, where the cavity 322 is between the base of the archwire slot 304 and the bonding base. Other embodiments may comprise other reception features such as one or more tracks for receiving the shutter 320. The tracks may be linear, angled, or curved. The tracks may or may not be located between the base of the archwire slot 304 and the bonding base. Other alternatives may have the locking shutter 320 slidably fastened or rotatably fastened to the body.

The orthodontic tool used to facilitate installation and removal of the shutter may comprise a scaler, an explorer, tweezers, or pliers.

Finally, it will be understood by one skilled in the art that the above-described embodiments are presented as examples only, with various modifications and alternatives permitted within the scope of the invention, (such as reversing the orientation of opening) which is not to be considered limited by the specific embodiments disclosed.

1. An orthodontic bracket comprising:
a body including a bonding base for attachment to a tooth, the bonding base having a curvature generally corresponding to the curvature of the tooth;
at least one gingival tie wing extending labially from the body;
at least two mesiodistally-spaced occlusal tie wings extending labially from the body;
an archwire slot extending mesiodistally across the body between the gingival tie wing and the occlusal tie wings, the archwire slot having a lingual base; the lingual base having a hole extending labial-lingually through the bonding base; and
a locking shutter moveable between an open position in which placement and removal of said archwire is facilitated and a closed position in which placement and removal of said archwire is inhibited, the bracket body further comprising a cavity within the body for receiving at least a portion of the locking shutter;
wherein the at least a portion of the locking shutter forms a back of the archwire slot in the hole.

2. The orthopedic bracket according to claim 1, wherein when the locking shutter is placed in the closed position, the hole is closed by the at least a portion of the locking shutter.

3. The orthodontic bracket according to claim 1, wherein the hole is centrally located mesiodistally along the archwire slot.

4. The orthodontic bracket according to claim 1, wherein the hole is located off-center within the archwire slot.

5. The orthodontic bracket according to claim 1, wherein the hole comprises two or more holes.

6. The orthodontic bracket according to claim 1, wherein the hole is a shape selected from circular, square, ellipse, rectangle, and irregular-shaped.

7. The orthodontic bracket according to claim 1, further comprising one or more tracks for receiving the shutter.

8. The orthodontic bracket according to claim 7, wherein the tracks are one of linear, angled and curved.

9. The orthodontic bracket according to claim 7, wherein the tracks are located between the bonding base and the lingual base of the archwire slot.

10. The orthodontic bracket according to claim 1, wherein the locking shutter is slidably fastened to the body.

11. The orthodontic bracket according to claim 1, wherein the locking shutter is rotatably fastened to the body.

12. The orthodontic bracket according to claim 1, wherein the cavity is between the bonding base and the lingual base of the archwire slot.

13. The orthodontic bracket according to claim 1, wherein the locking shutter comprises a tool hole.

14. The orthodontic bracket according to claim 13, wherein the tool hole is aligned with the hole so that the dental tool may enter the tool hole and the hole to provide additional leverage during installation and removal of the shutter.

15. The orthodontic bracket according to claim 13, wherein the hole is aligned mesiodistally with the tool hole.

16. The orthodontic bracket according to claim 1, wherein the locking shutter is constructed from at least one of a resilient nickel-titanium, chromium-cobalt, titanium-molybdenum, and spring steel material.

17. The orthodontic bracket according to claim 1, wherein the hole is shaped to receive a tool to facilitate placement of the orthodontic bracket.

18. An orthodontic bracket comprising:
a body including a bonding base for attachment to a tooth, the bonding base having a curvature generally corresponding to the curvature of the tooth; the body having a cavity therein for receiving at least a portion of a locking shutter;
at least one gingival tie wing extending labially from the body;
at least two mesiodistally-spaced occlusal tie wings extending labially from the body;
an archwire slot extending mesiodistally across the body between the gingival tie wing and the occlusal tie wings, the archwire slot having a lingual base; the lingual base having a hole centrally located mesiodistally and extending labial-lingually through to the cavity; and
a locking shutter moveable between an open position in which placement and removal of said archwire is facilitated and a closed position in which placement and removal of said archwire is inhibited, the bracket body further comprising a cavity within the body for receiving at least a portion of the locking shutter;
wherein the at least a portion of the locking shutter forms a back of the archwire slot in the hole.

19. The orthodontic bracket according to claim 18, wherein the cavity is between the bonding base and the lingual base of the archwire slot.

20. The orthodontic bracket according to claim 18, wherein the hole centrally located mesiodistally along the archwire slot.

21. The orthodontic bracket according to claim 18, wherein the hole is a shape selected from circular, square, ellipse, rectangle, and irregular-shaped.
